(19) United States
(12) Patent Application Publication
(10) Pub. No.: US 2015/0332375 A1
(43) Pub. Date: Nov. 19, 2015

(54) FULFILLMENT OF REGISTERED GIFTS AND OTHER ITEMS BASED ON USER-DEFINED DELIVERY PARAMETERS

(71) Applicant: Zola, Inc., New York, NY (US)

(72) Inventors: Shan-Lyn MA, New York, NY (US); Nobuyuki NAKAGUCHI, Jackson Heights, NY (US); Keith TSUI, Forest Hills, NY (US)

(73) Assignee: Zola, Inc., New York, NY (US)

(21) Appl. No.: 14/280,970

(22) Filed: May 19, 2014

(51) Int. Cl. G06Q 30/06

(52) U.S. Cl. CPC G06Q 30/0633

(57) ABSTRACT

The invention relates to systems and methods of delivering items purchased from a gift registry based on user-defined delivery parameters, allowing users to request currency items as gifts, and exchanging items for other items, and providing group purchase items. The system may receive from a recipient user an identification of one or more items to be added to the gift registry and one or more delivery parameters that indicates a delivery date used to time delivery of the one or more items. When an item is purchased by others for the recipient user, the recipient user may elect to retain the purchased item, exchange the purchased item for another item, or transfer a currency value of the purchased item to a financial account. One or more items of the gift registry may also be flagged as a group item, in which multiple giving users may together purchase the group item.

### FIELD OF THE INVENTION

The invention relates to systems and methods of delivering items purchased from a gift registry based on user-defined delivery parameters, allowing users to request currency items as gifts, and exchanging items for other items.

### BACKGROUND OF THE INVENTION

A gift registry typically allows a recipient to specify items they would like to receive for a special occasion such as a wedding, an anniversary, a graduation, a birthday, etc. The gift registry may be accessible via a website or other interface provided by a retailer so that others may view and purchase the specified items. Once purchased, an item is delivered to an address specified by the recipient. However, such deliveries can be inconvenient if made when the recipient is not available to accept delivery, or is otherwise busy making preparations for the special occasion.

Furthermore, retailers typically provide their own gift registries. Thus, a recipient who wishes to receive items from different retailers may be required to create an individual gift registry for each retailer.

Additionally, conventional gift registries are often limited to items offered by a given retailer. Thus, users are unable to request real currency as a gift. Conventional gift registries also typically lack an easy mechanism to exchange received items for other items on the gift registry, cash, or other items having real or perceived value. Thus, recipients are often unable to easily change their minds with respect to an item added to the gift registry when the item has already been purchased.

### SUMMARY OF THE INVENTION

The invention addressing these and other drawbacks relates to systems and methods of delivering items purchased from a gift registry based on user-defined delivery parameters, allowing users to request currency items as gifts, exchanging items for other items, and/or taking other actions in relation to the gift registry, according to an aspect of the invention. The gift registry may be separate from gift registries offered by retailers and may include items from various retailers.

The system may receive an identification of one or more items to be added to the gift registry and one or more delivery parameters that indicate at least a delivery date (e.g., date and/or time of day) to deliver the one or more items after the items have been purchased by others using the gift registry. The delivery date may include a date range, a date after which to deliver the item, and/or other information that specifies when a purchased item should be delivered. The delivery parameters may also specify a delivery location for the purchased item. For example, a recipient user may specify one or more items to add to the gift registry, and a date parameter that indicates when the items should be delivered.

A given set of delivery parameters may relate to the entire gift registry (e.g., all items in the gift registry that can be delivered), to a group of items that can be delivered, or to a specific item that can be delivered. For example, when a given item from the gift registry is purchased, the system may consult an appropriate set of delivery parameters for the given item and cause the delivery to occur at a location and/or date that is specified by the appropriate set of delivery parameters.

In an implementation, the recipient user may specify that a given item is a group item, which allows multiple giving users to contribute to the purchase of the given item (e.g., provide a portion of the purchase price). In this implementation, a particular item may be indicated as a group item that may be purchased by multiple giving users over multiple purchase transactions, while another item that is not a group item must be purchased in a single purchase transaction. In other implementations, all items may be treated as a group item.

Various types of items, and items from various retailers, may be added to the gift registry, allowing the recipient user to specify a wide range of desired items. For example, the one or more items may include an item from a partner item provider, an item from a third party item provider, a currency item, and/or other types of items. Each item may be associated with a purchase price. For example, for partner items and third party items, the purchase price may include the price required for purchase (which may or may not include processing fees, taxes, etc.). For currency items, the purchase price may include an amount of real or virtual currency desired by the recipient user. The amount of real currency may include an amount of legal tender. The amount of virtual currency may include a credit to purchase partner items and/or acquire other items. The recipient user may specify that one or more items in the gift registry be provided to another party such as a charity. In this manner, at least a portion of the gift registry may be donated.

A partner item provider may include an entity that provides partner items to the operator of the system (e.g., the gift registry provider) so that the system acts as a retail outlet for the partner item provider. Thus, a partner item may be associated with a retail margin that benefits the operator of the system when the item is added to and purchased from a gift registry. For example, a given partner item may be acquired by the system for a price of fifty dollars from a partner item provider. If selected by the recipient user, the system may add the given partner item to the gift registry with a purchase price of eighty dollars. When purchased by a giving user for one hundred dollars, the system may benefit from the retail margin of thirty dollars for the given partner item.

The third party item provider may include a retailer, a manufacturer, and/or other entity that provides a third party item in a manner that the system does not act as a retail outlet. For example, the system may allow a recipient user to add items from different retailers, providing greater flexibility over conventional gift registries. In an implementation, when purchased, all or a portion of the purchase price of a third party item (which may include government sales taxes and/or payment processing fees) may be credited to a financial account (e.g., deposited to a bank account) of the recipient user. The recipient user may then purchase the third party item from the third party item provider or simply transfer an amount of the purchase price to a financial account of the recipient user. In this manner, the giving user may be given the impression that the third party item was purchased for the recipient user when, in fact, the purchase price was credited to the financial account of the recipient user (and debited from a payment account of the giving user). In another implementation, the system may arrange the purchase and delivery of the third party item based on a relevant set of delivery parameters.

A currency item may include an amount (e.g., purchase price) of real or virtual currency that is desired by the recipient user. A giving user may contribute all (or a portion of) the purchase price. Multiple currency items may be included, each specified by the recipient user as having a different purpose (e.g., a currency item for a honeymoon, another currency item for a down payment for a home, etc.). In this manner, the recipient user may specify different intended purposes of a given currency item, and giving users may select from among the different intended purposes they wish to fund.

To allow the recipient user to monitor and interact with the gift registry, the system may generate and provide one or more tracking reports. For a given item, the one or more tracking reports may include, without limitation, status information related to the given item, a description, an amount of the purchase price that was funded, an amount of funds that is available for transfer, one or more actions to be taken, and/or other information related to a given item.

The one or more tracking reports may be sorted by date of purchase, giving recipients, items, and/or other information. In this manner, the recipient user may customize the manner in which the tracking reports are presented.

As items are partially or fully purchased through the gift registry, the system may facilitate fulfillment (e.g., delivery, funds transfer, etc.) of the items in various ways. For example, an item may be fulfilled by delivering the item, transferring an amount of currency related to the item, allowing an exchange of the item, and/or allowing the item or value thereof to be transferred to the recipient user.

In an implementation, an item that was fully purchased (e.g., the full purchase price has been paid by one or more giving users) may be delivered based on one or more delivery parameters. For a partially purchased item (e.g., an item for which only a portion of the purchase price was paid by a giving user), a recipient user may pay any remaining portion of the purchase price.

In an implementation, the system may provide an exchange mechanism for fulfilling items. An item that was partially or fully purchased may be exchanged for other items of the same or different type. For example, a third party item that was partially or fully purchased may be exchanged for another third party item, a partner item and/or a currency item, up to an equivalent value that was purchased. Other items may be similarly exchanged. In this manner, the system may provide flexibility for the recipient user to exchange items that were purchased for items that were not purchased (or to receive real or virtual currency equivalents).

In an implementation, the manner in which fulfillment of items (including exchanges) may occur may be specified by one or more fulfillment rules. Different types of items may be subject to different fulfillment rules. In this implementation, for example, the manner in which a partner item may be fulfilled (including exchanged with other items) may be different than the manner in which a third party item may be fulfilled.

In an implementation, using the one or more fulfillment rules, the system may encourage the exchange of third party or currency items to partner items to take advantage of the retail margin associated with the partner items. For example, the system may apply a multiplier (which may be specified by the one or more fulfillment rules) to the purchase price of third party or currency items to obtain an equivalent (higher) purchase price for partner items. A multiplier of 1.1 (or other value) may be applied to the purchase price of a third party item to obtain an equivalent purchase price of a partner item. In the foregoing example, a third party item that was fully purchased for 100 dollars may be exchanged for a partner item that costs 110 dollars, assuming that the partner item has a retail margin in excess of ten dollars. Similarly, the third party item may be exchanged for 110 dollars of virtual currency used to purchase partner items that have retail margins exceeding ten dollars.

In an implementation, the system may allow a recipient user to request that a given item be fulfilled at any time, which may override relevant delivery parameters. For example, the system may allow the recipient user to request that a given item be delivered regardless of the delivery date that may be specified in a delivery parameter. The system may also allow the recipient user to transfer all or a portion of available funds to the financial account of the recipient user at any time. The available funds may include partial or full purchases of items that have not yet been fulfilled (e.g., delivered, transferred as currency, etc.).

By allowing a recipient user to specify delivery parameters, add items from various retailers, add currency items, exchange items for other items, specify group gifts, and/or taking other actions in relation to the gift registry, the system may provide a more customizable and flexible gift registry.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a system of user-defined delivery parameters used to fulfill items that were added to a gift registry by a recipient user, and purchased or funded by others for the recipient user based on the gift registry, according to an implementation of the invention.

FIG. 2 illustrates an exemplary user interface used to purchase an item in the gift registry, according to an implementation of the invention.

FIG. 3A illustrates an exemplary portion of a tracking report grouped by type of item, according to an implementation of the invention.

FIG. 3B illustrates an exemplary portion of a tracking report grouped by type of item, according to an implementation of the invention.

FIG. 3C illustrates an exemplary portion of a tracking report grouped by type of item, according to an implementation of the invention.

FIG. 4 illustrates an exemplary tracking report grouped by date and giving user, according to an implementation of the invention.

FIG. 5A illustrates an exemplary user interface used to verify a fund transfer in relation to a purchased item, according to an implementation of the invention.

FIG. 5B illustrates an exemplary user interface used to verify a delivery request in relation to a purchased item, according to an implementation of the invention.

FIG. 6 illustrates a process of user-defined delivery parameters to fulfill items that were added to a registry by a user and purchased or funded by others for the user based on the registry, according to an implementation of the invention.

FIG. 7 illustrates a process of processing and storing items specified by a user into a registry, according to an implementation of the invention.

### DETAILED DESCRIPTION OF THE INVENTION

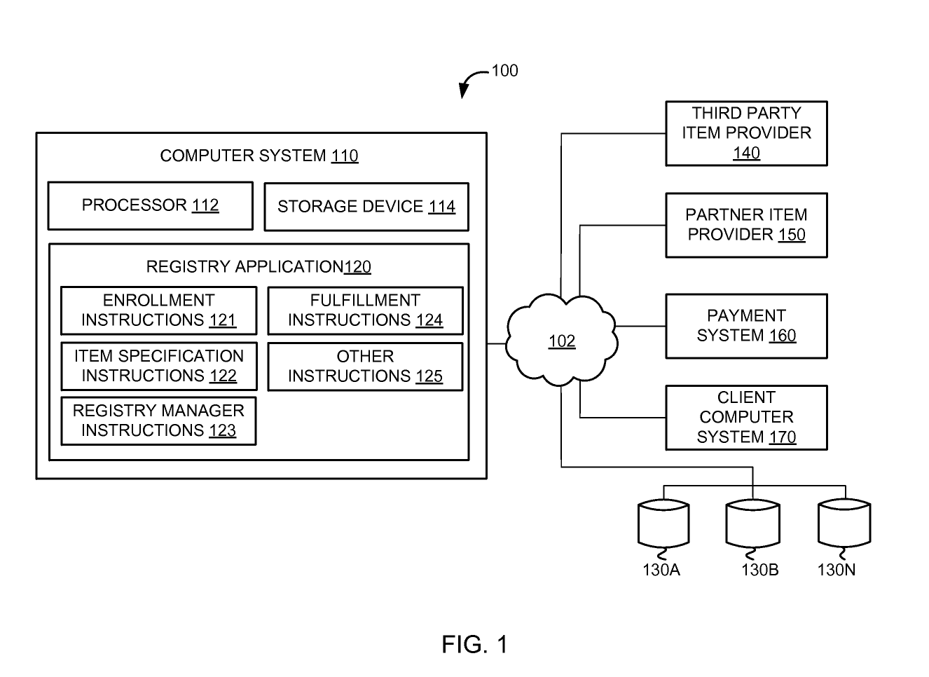

FIG. 1 illustrates a system 100 of user-defined delivery parameters used to fulfill items that were added to a gift registry by a recipient user, and purchased by others for the recipient user based on the registry, according to an implementation of the invention. As used herein, the terms “purchase,” “purchased,” and similar terms include a payment for a physical item that can be delivered to a recipient user, a payment for a service item that can be performed for the recipient user, a payment for a currency item that causes an amount of currency related to the currency item to be funded and transferred to a financial account of the recipient user, and/or other payments related to providing an item to the recipient user.

The system may be used by recipient users to add items from different retailers to a gift registry, specify a delivery date and/or location to receive items that were purchased through the gift registry, request currency (e.g., cash) gifts using the gift registry, exchange one type of item for another type of item (e.g., an item for cash, an item for another item, an item for credits, etc.), track the status of the gift registry, request partial or full payment of currency that was provided by others, and/or perform other functions related to the gift registry. One or more items in the gift registry may be provided to an entity other than a recipient user. For example and without limitation, a recipient user may specify that a given item be provided to a charity.

Other uses of system 100 are described herein and still others will be apparent to those having skill in the art. Having described a high level overview of some of the system functions, attention will now be turned to various system components that facilitate these and other functions.

System 100 may include a computer system 110, one or more databases 130 (illustrated in FIG. 1 as databases 130A, 130B, . . . , 130N), a third party item provider 140, a partner item provider 150, a payment system 160, a client computer system 170, and/or other components.

Computer system 110 may include one or more processors 112 (also interchangeably referred to herein as processors 112 or processor 112 for convenience) programmed by computer program instructions including a registry application 120, which may include one or more sets of instructions that program the one or more processors 112. For example, registry application 120 may include, without limitation, enrollment instructions 121, item specification instructions 122, registry manager instructions 123, fulfillment instructions 124, and/or other instructions 125. For convenience, the various instructions will be described hereinafter as performing an operation, when, in fact, the various instructions program processors 112 (and therefore computer system 110) to perform the operation.

Enrollment to Set Up a Gift Registry

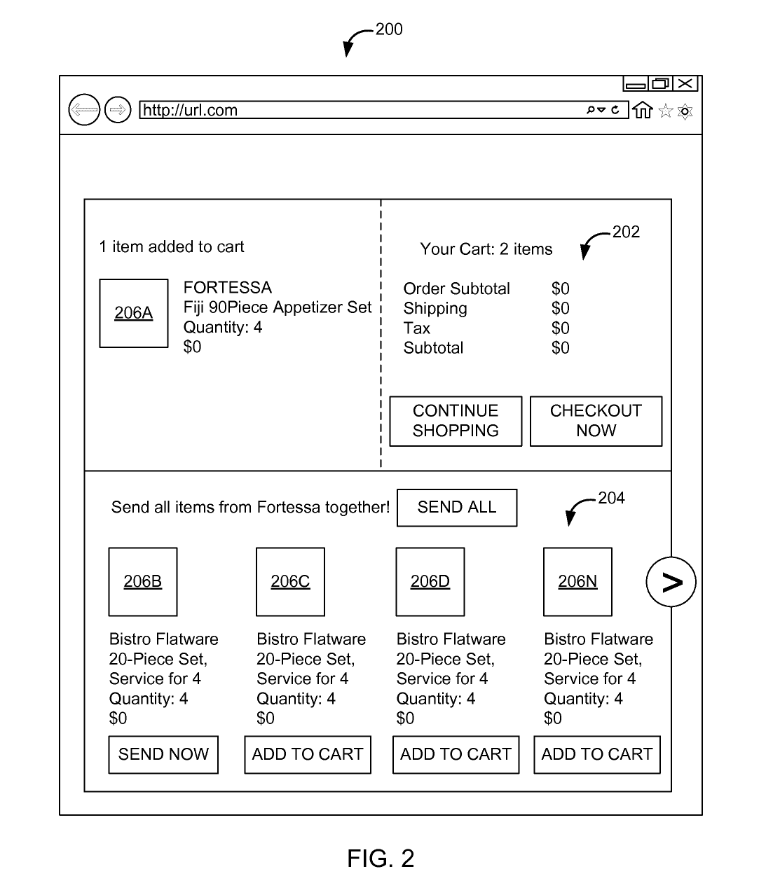

In an implementation, enrollment instructions 121 may provide one or more user interfaces used to facilitate enrollment in the system by one or more entities. The various user interfaces described herein (and illustrated by FIGS. 2, 3A, 3B, 3C, 4A, 4B, 5A, and 5B) may include, without limitation, a web-based interface (e.g., a website), electronic mail interface, a mobile application interface, one or more application programming interfaces, and/or other interfaces that may be pulled by users and/or pushed to users.

The entities may include, without limitation, a user (also referred to herein as a “recipient” or “recipient user”) that creates a gift registry, an item provider that partners with or otherwise provides items, and/or other entities. The user may include one or more individuals or organizations that use the system to create a gift registry. For example, and without limitation, the one or more individuals may include a single individual, more than one individual (e.g., an engaged couple), a charitable organization, and/or other entities.

When enrolling a user, enrollment instructions 121 may receive user enrollment information from the user during the enrollment process. The user enrollment information may include, without limitation, a name of the user, demographic information related to the user, payment account information, gift registry information, and/or other information.

The name of the user may include, without limitation, a name of a recipient user, names of multiple recipient users (e.g., couples), a name of an organization, and/or a name of other entities. The demographic information may include information related to the user such as, without limitation, a mailing address, an age, a gender, and/or other information that describes the user.

The payment account information may include information that identifies a payment account used to credit and/or debit funds related to items in the gift registry, and/or debit funds to pay for any items on the gift registry that were not completely purchased by givers and that the recipient user wishes to purchase. For example and without limitation, the payment account may include a bank account, a payment account of an online payment service (e.g., PAYPAL), a credit card account, and/or other payment account that may be used to credit and/or debit funds.

The gift registry information may include a name of the gift registry, a special occasion date, a type of special occasion (e.g., wedding, birthday, anniversary, etc.), venue information related to the special occasion, and/or other information associated with the gift registry. The venue information may specify a location where an event related to the special occasion will occur. In this manner, the gift registry information may include invitation information, which may be broadcast to all or a portion of other users who provide funds for items in the gift registry (also referred to herein as a “giver” or a “giving user”).

In an implementation, at least some of the foregoing information may be received after the enrollment process. Regardless of when the information is received, enrollment instructions 121 may store the user enrollment information in a gift registry database (such as a database 130) to thereby create a gift registry for the recipient user.

Adding Items to the Gift Registry

In an implementation, upon creation of a gift registry for a recipient user, item specification instructions 122 may provide one or more user interfaces used to receive an identification of one or more items that a user wishes to add to the gift registry. A given item may include a product, a service, real currency (e.g., funds denominated in legal tender), virtual currency (e.g., a credit toward a product or service), and/or other item of value or perceived value that may be purchased by (e.g., paid for or transferred by) a giving user for the recipient user.

A recipient user may identify an item to be added to the gift registry through the one or more user interfaces, via a mobile application scanner, and/or other technique. The mobile application scanner may include a mobile application installed at a mobile device of the recipient user that allows the user to scan items of interest to add the items to the gift registry. Other ways of adding items to the registry may be used as would be apparent to those having skill in the art.

In connection with an item to be added, item specification instructions 122 may obtain item specification information that may include, without limitation, item identification information, an item description, a desired quantity or volume of the item, a purchase price of the item, a source of the item, a group fund indication, a processing fee designation, one or more delivery parameters, and/or other information that describes the item. Some or all of the item specification information may be obtained automatically (e.g., through a database query), input by the recipient user, and/or otherwise obtained by item specification instructions 122.

The item identification information may be used to identify an item and may include, without limitation, a Universal Product Code (“UPC”), a Quick Response (“QR”) code, a catalog number, and/or other identification information that can be used to identify the item. The item description may include a general description of the item, a name brand or manufacturer of the item, and/or other descriptive information. The desired quantity or volume may indicate the quantity or volume of the item that the recipient user desires. The purchase price of the item may relate to a price of a product or service, an amount of real currency, an amount of virtual currency, and/or other valuation for the item that is to be paid for by one or more giving users. The source of the item may indicate a source of the item, such as whether the item is provided by a third party item provider or a partner item provider.

The group fund indication may indicate whether a given item may be funded by more than one giving user. In this manner, the recipient user may allow for group buying of higher priced items.

The processing fee designation may identify a party that is to pay for processing fees charged by a payment service. For example, credit cards generally charge retailers a percentage of the purchase amount in connection with processing credit card payments. Because giving users may use a credit card (or other payment account that charges fees) to fund an item, the amount funded by a giving user may not be sufficient to pay for the purchase price of the item. The recipient user may specify whether to charge any processing fee to the giving user or whether the recipient user will cover the processing fee. For example, if charged to the giving user, the purchase price of the item may be adjusted to account for the processing fee. On the other hand, if charged to the recipient user, the purchase price of the item will not be adjusted. The processing fee designation may be applied to individual items, groups of individual items, or all items in the gift registry.

The one or more delivery parameters specify a location, a time, and/or other parameter that is used to fulfill a given item (e.g., to deliver a physical item, deposit an amount of currency, etc.). The location may specify an address or other location at which to deliver a physical item. The time may indicate a date, a time of day, a range of dates, a range of times of day, and/or other time to fulfill the given item. In this manner, the recipient user may specify where and/or when the item is to be fulfilled.

In an implementation, the one or more delivery parameters may apply only to physical items that are to be delivered. For example, currency items may be fulfilled at any time that funds for the currency items are available.

In an implementation, the one or more delivery parameters may be specific to a particular item or group of items. For example, some items may be associated with a first set of delivery parameters while other items may be associated another set of delivery parameters. In an implementation, the one or more delivery parameters may be applicable to all of the items in the gift registry. For example, the one or more delivery parameters may be specified during user enrollment, and may be applicable to all items in the gift registry.

In an implementation, the one or more delivery parameters may be received by the system from the recipient user prior to providing the gift registry to a giving user. Thus, the one or more delivery parameters may be specified by the recipient user before a purchase for an associated item is made.

Adding Third Party Items

In an implementation, an item may be provided by a third party item provider 140, which may not be affiliated with the system. By allowing the recipient to specify desired items from one or more third party item providers, the system allows the recipient to add items provided by any retailer or other item provider to the gift registry even if the retailer has no association with the system. In this manner, the recipient may not be limited to a given retailer for a gift registry.

Because details for a third party item may not be known by the system, item specification instructions 122 may obtain a link (e.g., a Uniform Resource Locator (“URL”)) or other electronic address associated with the third party item. For example, the recipient user may specify the link when adding the item to the gift registry. Item specification instructions 122 may store the link in the gift registry database in association with the item so that the link may be provided when displaying the item for potential purchase by giving users.

In an implementation, item specification instructions 122 may visit the link to crawl associated content using conventional methods, such as Hyper Text Markup Language parsing techniques. The content may include, without limitation, an image related to the item, an item description, a purchase price, and/or other item information. Item specification instructions 122 may store the crawled content in association with the item so that some or all of the content may be provided to giving users in association with the gift registry.

Adding Partner Items

If an item is a product or service, the item may be provided by a partner item provider 150, which may be associated with the system. Partner item provider 150 may include, without limitation, a manufacturer, a retailer, and/or other entity that may provide items to be sold through the system (e.g., through contractual or other arrangements). In this manner, the system may act as a retail outlet for partner item provider 150.

In an implementation, some or all of the item specification information may be stored in a partner item database that pre-stores such information. If a given item is not in the partner item database, then some or all of the corresponding item specification information may be obtained as described herein with respect to third party item provider 140.

Adding Currency Items

If an item is a currency item (e.g., an amount of real or virtual currency), the item specification information may include a description that indicates a purpose for the currency item. For example, and without limitation, the recipient user may specify that the purpose of a given currency item is to fund a honeymoon trip, make a down payment on a house, and so on. A given currency item may be associated with a link and/or additional information related to the purpose of the given currency item. For example, the recipient user may specify a link to a cruise carrier, a link to a real estate listing, and/or other information related to the purpose of the given currency item. In this manner, the link and/or additional information may be provided to giving users in association with the currency item.

In an implementation, more than one currency item may be added to the gift registry by the recipient user, each with its own corresponding description. In this manner, different currency items for different purposes may be included in the gift registry so that giving users may select a given currency item to purchase based on its stated purpose.

Presenting Items for Purchase and Processing the Purchases

In an implementation, registry manager instructions 123 may provide one or more user interfaces that allow giving users to search for, view, and purchase items in the gift registry. Such user interfaces may be configured using conventional electronic commerce/shopping techniques used to display items for sale. For example, each item in the gift registry may be displayed along with an item description, one or more images related to the item, a purchase price, a name brand, a retailer name, and/or other information related to the item.

Upon receiving an indication to purchase an item, registry manager instructions 123 may provide an interface to confirm the purchase. Referring to user interface 200 illustrated in FIG. 2, for example, an electronic cart 202 may be displayed that indicates one or more items (illustrated as item 202A) that are to be purchased by the giving user. Suggestion section 204 may include suggested items (illustrated as items 202B, 202C, 202D, . . . , 202N) to purchase, which may be related to the items in electronic cart 202. The items added to electronic cart 202 may include currency items, third party items, partner items, and/or other types of items. In an implementation, contact information (e.g., a name, an electronic mail address, a postal address, etc.) for each of the giving users that partially or fully purchased an item may be stored in the registry database in order to facilitate “thank you” notes from the recipient user. Such notes may be automatically generated by the system at a particular date and/or responsive to a request from the recipient user.

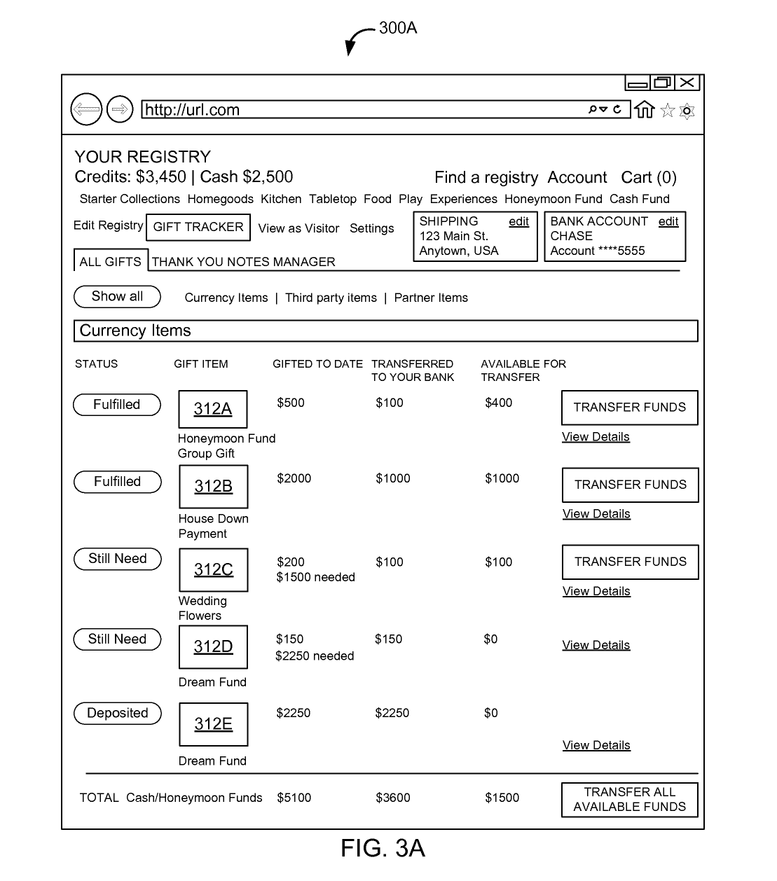

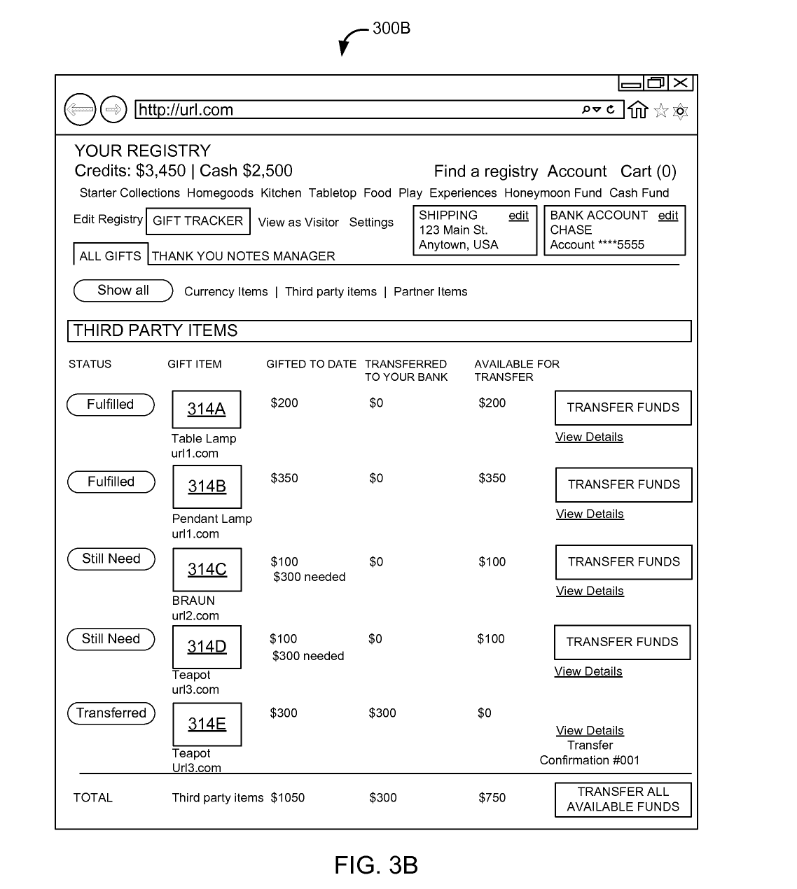

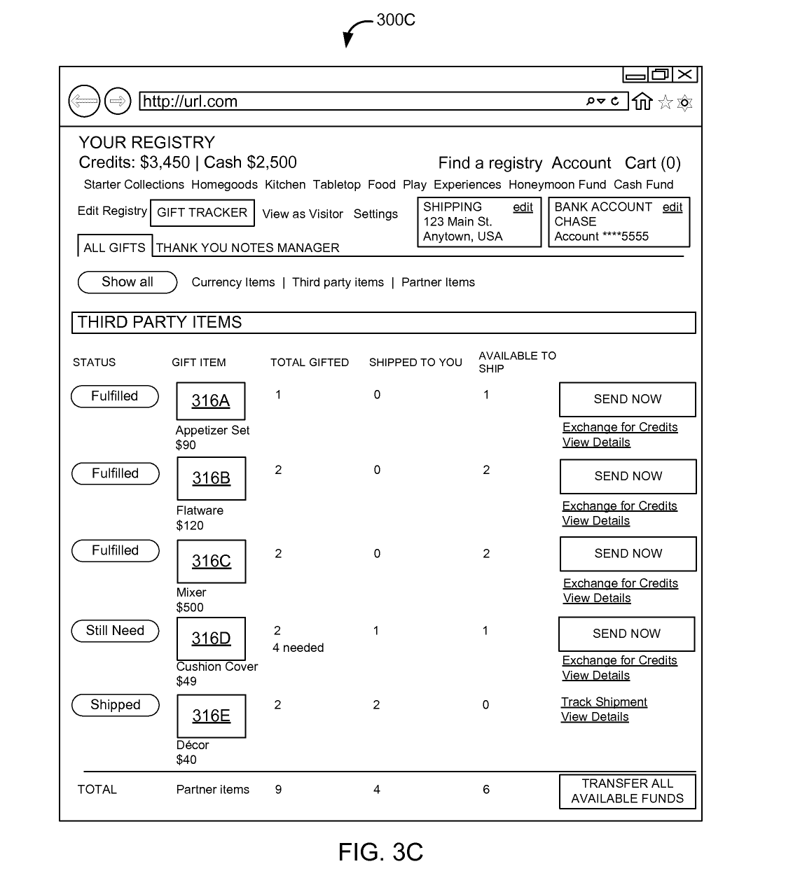

The various user interfaces illustrated in FIG. 2 (and in other drawing figures, such as FIGS. 3A, 3B, 3C, 4, 5A, and 5B) are for illustrative purposes only and are not intended to be limiting. For example, various user interface objects may be added, deleted, and/or formatted differently than as illustrated. Furthermore, user interactions with the user interface may be communicated to the various instructions of correlation application 120, which may respond accordingly. For example, interaction with a user interface object may cause correlation application 120 to take certain actions associated with the user interface object.

In an implementation, registry manager instructions 123 may process purchases made by giving users. For example, through one or more of the user interfaces, registry manager instructions 123 may obtain and store purchase information such as, without limitation, an identity of a giving user that partially or fully funded an item, a time (e.g., date and/or time of day) that the item was partially or fully funded (including a partial amount funded, if applicable), a payment method used to fund the item, and/or other information related to the purchase. Registry manager instructions 123 may store the purchase information in a gift registry tracking database (such as one or more databases 130). In this manner, registry manager instructions 123 may maintain a record of purchases related to the gift registry.

In an implementation, registry manager instructions 123 may process payments for the purchases. For example, registry manager instructions 123 may submit a payment request to payment system 160 using payment information that is provided by a giving user to at least partially fund an item on the gift registry. The payment information may include, without limitation, a credit card number, a debit card number, an online payment service account identifier, and/or other information used to request and receive payment. The payment request may be formatted according to conventional industry-standard payment requests and/or other format suitable for requesting payment from payment system 160.

In an implementation, registry manager instructions 123 may process the payment information at the time that the giving user at least partially funded an item. For example, upon submission of the payment information by the giving user (e.g., through one or more of the user interfaces generated by the system), registry manager instructions 123 may generate and submit the payment request to payment system 160. In other implementations, registry manager instructions 123 may store the payment information (de-identified/encrypted as appropriate) for later processing, such as when the fulfillment date as specified by the fulfillment parameters is approaching, when the recipient user requests fulfillment, and/or at other times.

In an implementation, registry manager instructions 123 may credit different financial accounts depending on the type of item that was purchased (assuming the payment request was authorized). For example, for a partner item purchase, a financial account associated with the system may be credited with the payment. For a currency item purchase, a financial account associated with the recipient user may be credited with the payment. For a third party item purchase, a financial account associated with the third party item provider may be credited (if, for example, the third party item provider has agreed contractually or otherwise to accept purchases from the system).

In an implementation, an account associated with the system may be credited regardless of the type of item that was purchased. In this implementation, the system may transfer funds to different financial accounts. For example, the purchase price of a currency item may be credited to the account associated with the system and, when requested by the recipient user, may be credited to a financial account of the recipient user.

In an implementation, registry manager instructions 123 may facilitate other events (other than purchases) related to items in the gift registry. For example, and without limitation, registry manager instructions 123 may facilitate item returns by the recipient (e.g., if the item is no longer wanted, is defective, etc.), updates to the gift registry (e.g., adding new items, updating or deleting existing items, etc.), and/or other events related to the items. Registry manager instructions 123 may provide an alert to the recipient user, the giving user, and/or other users responsive to various events. For example, and without limitation, registry manager instructions 123 may provide a notification to the recipient user that an item has been partially or fully purchased, a purchase confirmation to the giving user that confirms a partial or full purchase, and/or other notifications to other users.

Tracking the Status of Gift Registry Items

In an implementation, registry manager instructions 123 may generate and provide a tracking report related to gift registry items. For example, FIGS. 3A-3C collectively illustrate a tracking report 300 generated by registry manager instructions 123. As illustrated, tracking report 300 may be grouped by the type of item (e.g., whether the item is a cash item, a third party item, a partner item, etc.). For example, FIG. 3A illustrates a grouping 312 that includes currency items (illustrated as currency items 312A, 312B, 312C, 312D, 312E). Each currency item 312A-E may be associated and displayed with an image. The image may relate to a currency item. For example, a currency item related to a house down payment may include an image of a house. FIG. 3B illustrates a grouping 314 that includes third party items (illustrated as third party items 314A, 314B, 314C, 314D, 314E). FIG. 3C illustrates a grouping 316 that includes partner items (illustrated as partner items 316A, 316B, 316C, 316D, 316E). Each third party item and partner item may be associated and displayed with an image, such as an image of a partner item or third party item. Tracking report 300 may be formatted according to and communicated through one or more user interfaces described herein.

In an implementation, tracking report 300 may include, without limitation, a status of each item (e.g., an indication of whether an item was returned by a recipient user, an indication of whether the item was purchased, etc.), an amount of funds that have been provided by giving users toward each item, an amount of funds that have been transferred to the recipient user, an amount of funds that are available for transfer, and/or other information.

For each group (312, 314, 316), tracking report 300 may include aggregate statistics, such as, without limitation, an aggregate amount of funds gifted, an aggregate amount of funds transferred, an aggregate amount of funds available, an aggregate number of items in the group, an aggregate number of items partially or fully purchased, and/or other aggregate information for the group. As would be appreciated, tracking report 300 may alternatively or additionally include cumulative aggregates across all groups of items. Furthermore, tracking report 300 may list items that are not grouped.

In an implementation, the tracking report 300 may be sorted by, without limitation, group of item, date of purchase, date of addition, amount needed to be fully funded, amount remaining to be funded, whether fully funded, whether partially funded, and/or other metric by which the sorting may be achieved. In this manner, tracking report 300 may be customized by the recipient user or others.

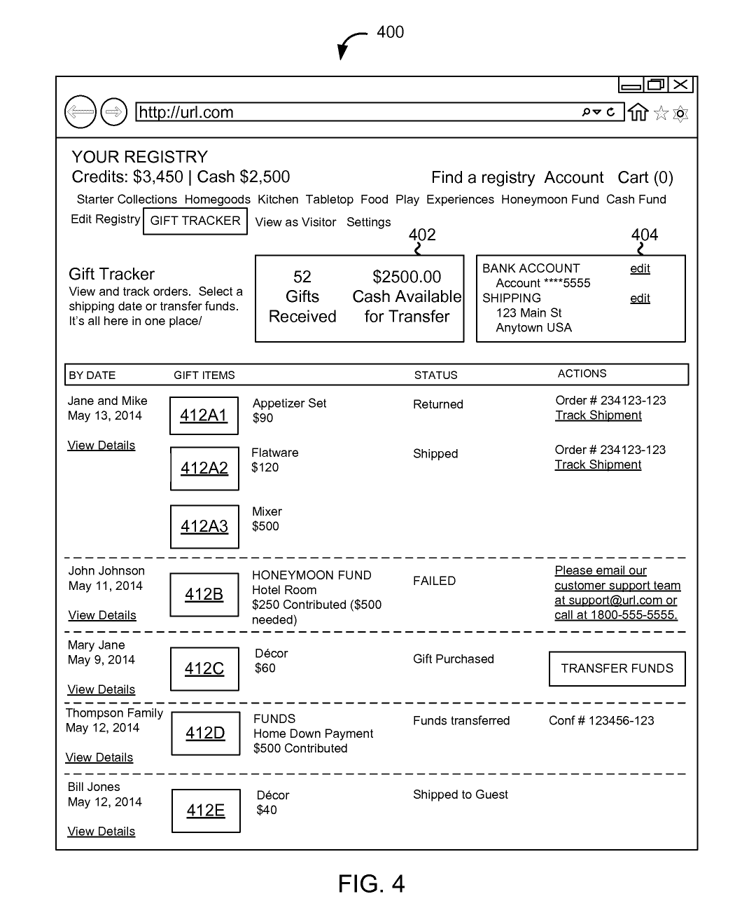

In an implementation, registry manager instructions 123 may generate tracking reports sorted by date of purchase and/or giving user. For example, referring to FIG. 4, tracking report 400 may include various sections 412A, 412B, 412C, 412D, 412E (collectively, “sections 412”) that each relate to a giving user (or a set of giving users). For example, section 412A relates to three items (illustrated as item 412A1, 412A2, 412A3) purchased by a giving user (which may include one or more giving users).

In an implementation, tracking report 400 may be used to indicate a status of each purchased item. For example, referring to section 412B, a transfer of funds related to a cash item may be indicated as having failed. The recipient user may be alerted of such failure in order to resolve the problem. Tracking report may also be used to indicate an overall status of the gift registry. For example, a dashboard section 402 may indicate a number of items received, a total amount of cash that is available to be transferred (and/or exchanged), and/or other information related to the gift registry. Fulfillment information section 404 may indicate a financial account of the recipient user, a delivery address of the recipient user, a delivery date (not illustrated), and/or other information that may be used in relation to fulfillment.

In an implementation, all or a portion of tracking report 300 and/or tracking report 400 may be downloaded as a spreadsheet file, a word processing file, and/or other format. In this manner, the system facilitates local manipulation of the tracking report (e.g., viewing, printing, and/or other interactions with the tracking reports).

In an implementation, registry manager instructions 123 may provide one or more alerts to the recipient user. An alert may be provided via a text message, an electronic mail message, an alert message when the user has logged into the system, and/or other type of communication channel. An alert may provide information that is included in one or more tracking reports described herein. An alert may also provide a reminder that a scheduled delivery is to occur, a shipping tracking number, and/or other information related to an item on the gift registry.

Fulfilling Purchases

In an implementation, fulfillment instructions 124 may fulfill purchased items as described herein in a semi-automated or automated mode. For example, in a semi-automated mode, fulfillment instructions 124 may provide an alert to a system operator that indicates that certain fulfillment requests have been made or that certain conditions specified by the one or more delivery parameters have been met (e.g., a delivery date for a purchased item is approaching). The system operator may facilitate fulfillment by generating delivery orders to deliver items, processing fund transfers by sending payment requests to payment system 150, and/or taking other actions. In an automated mode, fulfillment instructions 124 may facilitate fulfillment by taking the foregoing actions without intervention by a system operator.

Regardless of the manner in which items are fulfilled, in an implementation, once an item has been partially or fully purchased, fulfillment instructions 124 may fulfill the item according to one or more delivery parameters, one or more fulfillment rules, and/or other information.

In an implementation, the one or more fulfillment rules may specify the manner in which a given item may be fulfilled. For example, the system may facilitate a fulfillment exchange in which a purchased item may be exchanged with another item. The one or more fulfillment rules may dictate the types of exchanges that are permissible.

Table 1 illustrates an exemplary set of fulfillment rules that dictate different types of permissible exchanges that the recipient user may make, depending on the type of item. The rules illustrated in Table 1 are for illustrative purposes only and should not be viewed as limiting. Other rules may be used according to particular needs. For example, in some implementations, the rules may allow partner items to be transferred to real or virtual currency.

TABLE 1

| | Partner Items | Third party items | Currency Items |
|---|---|---|---|
| Fulfillment | Ship physical | Transfer Cash or | Transfer Cash |
| | product or | create purchase | |
| | cause service | order to third | |
| | to be | party | |
| | provided | | |
| Transfer to | No | Yes | Yes |
| Cash | | | |
| Convert to | Yes | Yes (with | Yes (with |
| Virtual | | optional | optional |
| Currency (e.g., | | incentive) | incentive) |
| Credits) | | | |
| Group Gifting | Yes | Yes | Yes |
| Partial Group | Exchange for | Exchange for | Exchange for |
| Gift Purchase | Virtual | Virtual | Virtual |
| | Currency (e.g., | Currency (e.g., | Currency (e.g., |
| | Credits) or pay | Credits) or | Credits) or |
| | difference | transfer | Transfer |
| | | partial cash, | Partial Cash |
| | | or pay | |
| | | difference | |

Fulfilling Partner Items Based on Fulfillment Rules

In an implementation, as illustrated in Table 1, partner items may be fulfilled by shipping the item or otherwise causing a service to be provided. A given partner item may be shipped according to the one or more delivery parameters. In an implementation, partner items may not be exchanged for real currency (e.g., cash), but may be exchanged for virtual currency (e.g., credits), which may be used to purchase other partner items and/or other items of value or perceived value. For group purchases of partner items, if only a portion of the purchase price has been funded, the recipient user may be allowed to exchange the portion of the purchase price to credits or may be allowed to pay the difference to fully fund the item.

Fulfilling Third Party Items Based on Fulfillment Rules

In an implementation, as illustrated in Table 1, third party items may be fulfilled by providing currency to the recipient user based on the purchase price (e.g., by crediting the recipient user's bank account with an amount of real currency). For example, instead of providing a third party item to the recipient user, fulfillment instructions 124 may allow the recipient user to instead receive an amount of currency that is based on the purchase price. The amount of currency may be the same as or different from the purchase price. The system may give the impression to the giving user that the third party item is being purchased for the recipient user, even though currency based on the purchase price is provided to the recipient user instead of the third party item.

In an implementation, third party items may be exchanged for virtual currency (e.g., credits) that may be used to purchase partner items. An incentive may be provided to exchange third party item purchases for virtual currency used to purchase partner items and/or other items of value or perceived value. The incentive may provide an additional value of credits above a cash value of the item. In this manner, the system may encourage recipient users to exchange items (or real currency) for virtual currency, which may be used to purchase partner items.

The incentive may be expressed as, without limitation, a multiplier of the purchase price, a set amount of virtual currency, and/or other way to specify an incentive. For example, an incentive may be associated with a multiplier that is 1.05 times the purchase price of an item. In the foregoing example, a third party item having a purchase price of 200 dollars (or other real currency denomination) may be exchanged for an amount of virtual currency that can be used to purchase partner items having a purchase price of 210 dollars. The incentive may be predefined for all items or configured specifically for a given item. The incentive may be beneficial for recipient users because they may obtain additional purchasing power to buy partner items. The incentive may be beneficial to the entity that operates the system because of the additional profit margin of partner items relative to other types of items.

For group purchases of third party items, if only a portion of the purchase price has been funded, the recipient user may be allowed to convert the portion to cash and/or credits. Alternatively, the recipient user may be allowed to pay the difference to fully fund the item.

Fulfilling Currency Items Based on Fulfillment Rules

In an implementation, as illustrated in Table 1, currency items may be fulfilled by providing the purchase price (e.g., cash value) of the currency item to the recipient user. The system may encourage exchanging the purchase price of the currency item to an amount of virtual currency that may be used to purchase partner items and/or other items of value or perceived value. As described with respect to third party items, the system may provide an incentive to exchange the cash value of the currency item to one or more credits. The incentive may be the same as or different from the incentive used with respect to third party items.

In an implementation, fulfillment instructions 124 may use the one or more fulfillment rules in combination with or instead of the delivery parameters, depending on the particular item that is to be fulfilled. For example, fulfillment instructions 124 may apply one or more fulfillment rules to facilitate an item exchange and use one or more delivery parameters to deliver the item that has been exchanged.

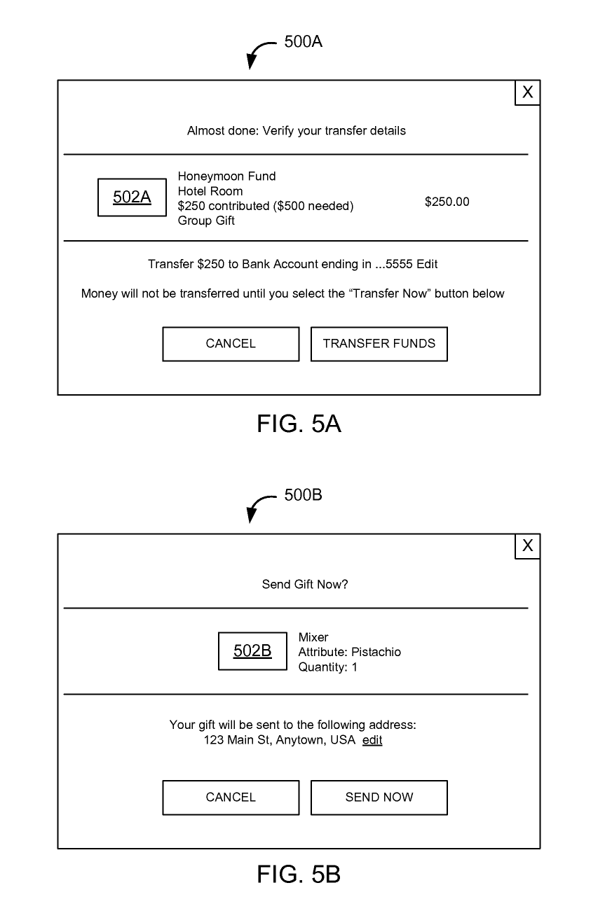

In an implementation, fulfillment instructions 124 may provide one or more user interfaces to receive fulfillment requests from recipient users to fulfill an item that was fully or partially purchased. For example, referring to FIG. 5A, user interface 500A illustrates an exemplary transfer interface that allows the recipient user to transfer a portion or all of a currency item 502A. In an implementation, user interface 500A may be provided in response to a selection of the “Transfer Funds” or “Transfer All Available Funds” buttons illustrated by user interfaces 300 and 400. User interface 500A may be provided in response to other interactions with other user interfaces as well.

As illustrated, the currency item relates to a requested amount of 500 dollars for a “honeymoon fund,” of which 250 dollars has been contributed. Upon receiving the fulfillment request (e.g., when the recipient user selects the “Transfer Now” user interface object), fulfillment instructions 124 may cause a financial account of the recipient user to be credited with 250 dollars. In other implementations, one or more additional user interface objects (not illustrated in FIG. 5A) may be included that, when manipulated, provides a user interface used to exchange a partially or fully purchased item for another item, pay any remaining amount due for partially purchased items, and/or take other fulfillment actions as described herein.

In an implementation, fulfillment requests may be used to request items to be shipped as well. For example, referring to FIG. 5B, user interface 500B illustrates an exemplary delivery interface used to request delivery of a purchased item 502B. For example, responsive to a selection (by the recipient user) of the “Send Now” user interface object, fulfillment instructions 124 may cause the item to be shipped to the recipient user. In an implementation, the delivery address may be obtained from the delivery parameters or a different address may be input by the recipient user (and received by computer system 110).

In an implementation, regardless of whether a delivery date is specified by the delivery parameters for the item and/or the gift registry, selection of the “Send Now” button may override the delivery date. In this manner, the recipient user may request immediate delivery of a given item, regardless of whether delivery parameters for the given item (and/or for the entire gift registry) have been set.

As with user interface 500A, user interface 500B may be provided responsive to user interactions with various user interfaces.

Although illustrated in FIG. 1 as a single component, computer system 110 may include a plurality of individual components (e.g., computer devices) each programmed by at least some of the instructions described herein. In this manner, some components of computer system 110 may perform some functions while other components may perform other functions, as would be appreciated. The one or more processors 112 may include one or more physical processors that are programmed by computer program instructions. The various instructions described herein are exemplary only. Other configurations and numbers of instructions may be used, so long as the processor(s) 112 are programmed to perform the functions described herein. Furthermore, it should be appreciated that although the various instructions are illustrated in FIG. 1 as being co-located within a single processing unit, in implementations in which processor(s) 112 includes multiple processing units, one or more instructions may be executed remotely from the other instructions.

The description of the functionality provided by the different instructions described herein is for illustrative purposes, and is not intended to be limiting, as any of instructions may provide more or less functionality than is described. For example, one or more of the instructions may be eliminated, and some or all of its functionality may be provided by other ones of the instructions. As another example, processor(s) 112 may be programmed by one or more additional instructions that may perform some or all of the functionality attributed herein to one of the instructions.

The various instructions described herein may be stored in a storage device 114, which may comprise random access memory (RAM), read only memory (ROM), and/or other memory. The storage device may store the computer program instructions (e.g., the aforementioned instructions) to be executed by processor 112 as well as data that may be manipulated by processor 112. The storage device may comprise floppy disks, hard disks, optical disks, tapes, or other storage media for storing computer-executable instructions and/or data.

The various components illustrated in FIG. 1 may be coupled to at least one other component via a network, which may include any one or more of, for instance, the Internet, an intranet, a PAN (Personal Area Network), a LAN (Local Area Network), a WAN (Wide Area Network), a SAN (Storage Area Network), a MAN (Metropolitan Area Network), a wireless network, a cellular communications network, a Public Switched Telephone Network, and/or other network. In FIG. 1 and other drawing Figures, different numbers of entities than depicted may be used. Furthermore, according to various implementations, the components described herein may be implemented in hardware and/or software that configure hardware.

The various databases 130 described herein may be, include, or interface to, for example, an Oracle™ relational database sold commercially by Oracle Corporation. Other databases, such as Informix™, DB2 (Database 2) or other data storage, including file-based, or query formats, platforms, or resources such as OLAP (On Line Analytical Processing), SQL (Structured Query Language), a SAN (storage area network), Microsoft Access™ or others may also be used, incorporated, or accessed. The database may comprise one or more such databases that reside in one or more physical devices and in one or more physical locations. The database may store a plurality of types of data and/or files and associated data or file descriptions, administrative information, or any other data.

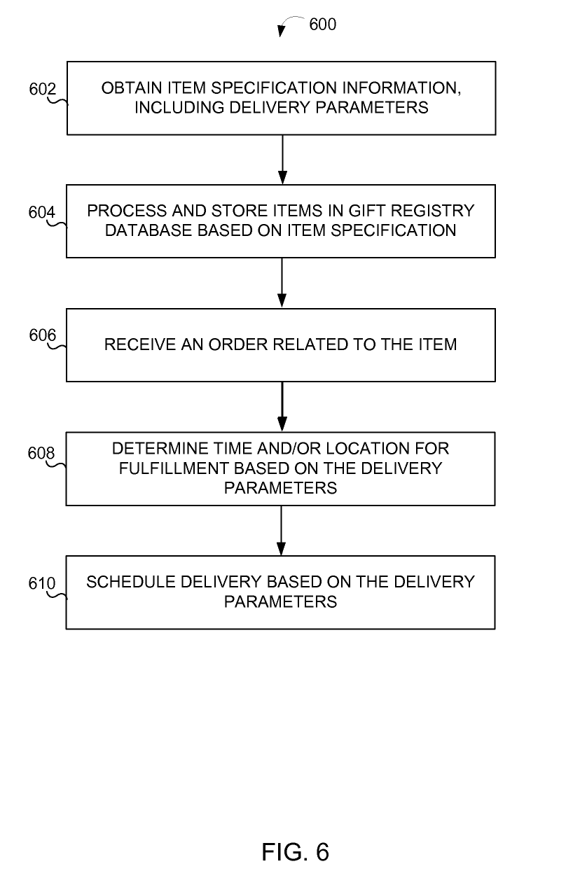

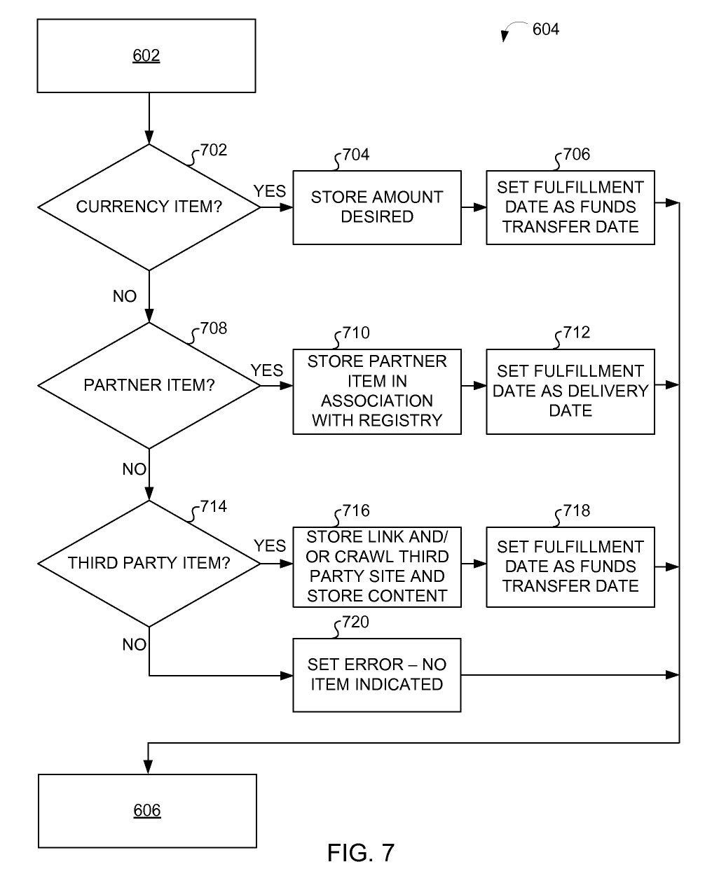

FIG. 6 illustrates a process 600 of user-defined delivery parameters to fulfill items that were added to a registry by a user and purchased or funded by others for the user based on the registry, according to an implementation of the invention. The various processing operations and/or data flows depicted in FIG. 6 (and in the other drawing figures, such as FIG. 7) are described in greater detail herein. The described operations may be accomplished using some or all of the system components described in detail above and, in some implementations, various operations may be performed in different sequences and various operations may be omitted. Additional operations may be performed along with some or all of the operations shown in the depicted flow diagrams. One or more operations may be performed simultaneously. Accordingly, the operations as illustrated (and described in greater detail below) are exemplary by nature and, as such, should not be viewed as limiting.

In an operation 602, item specification information for a plurality of items may be obtained from a recipient user. The item specification information may identify the plurality of items to be added to a gift registry. One or more delivery parameters may be obtained with (or as part of) the item specification information. The recipient user may specify the one or more delivery parameters to time the delivery of a given item that is purchased by giving users.

In an operation 604, the plurality of items may be processed and stored in a registry database, which may be used to provide a listing of the plurality of items for purchase by the giving users.

In an operation 606, an order related to a given item may be received. The order may include a full or partial payment for the given item. In an operation 608, a time and/or location for delivering the given item may be determined based on the one or more delivery parameters. In an operation 610, delivery of the given item may be scheduled based on the time and/or location.

FIG. 7 illustrates a process 604 of processing and storing items specified by a user into a gift registry database, according to an implementation of the invention.

In an operation 702, a determination of whether an item includes a currency item may be made. The currency item may represent an amount of currency that the recipient user wishes to receive as a gift. If the item is a currency item, the amount of currency desired may be stored in an operation 704. In an implementation, a fulfillment date may be set as a funds transfer date in an operation 706. In other words, the recipient user may set a particular date when funds should be transferred or may transfer funds at any time using one or more of the user interfaces described herein.

In an operation 708, a determination of whether an item includes a partner item may be made. If the item is a partner item, then information related to the partner item may be stored in association with the gift registry in an operation 710. In an operation 712, the fulfillment date may be set as the delivery date for the partner item. In an implementation, the delivery date may be specified by one or more delivery parameters.

In an operation 714, a determination of whether the item includes a third party item may be made. If the item is a third party item, a link to a third party item provider may be stored in association with the gift registry in an operation 716. Alternatively or additionally, the link may be crawled to obtain item information, which may be stored in association with the gift registry in operation 716.

In an operation 718, the fulfillment date may be set as a funds transfer date. In this implementation, third party items may be fulfilled as a currency value that is based on the purchase price of the third party item. In other implementations, the fulfillment date may be set as a delivery date for the third party item, which may be ordered from the third party on behalf of the recipient user.

In an operation 720, if a type of item is not recognized, an error message may be provided to the recipient user and/or a system operator. When all of the items have been processed (not illustrated), processing may proceed to operation 606 (referred to in FIG. 6).

Other implementations, uses and advantages of the invention will be apparent to those skilled in the art from consideration of the specification and practice of the invention disclosed herein. The specification should be considered exemplary only, and the scope of the invention is accordingly intended to be limited only by the following claims.

What is claimed is:

1. A computer implemented method of fulfilling items from a gift registry based on one or more delivery parameters specified by a recipient user, the method being implemented in a computer system having one or more physical processors programmed with computer program instructions that, when executed by the one or more physical processors, cause the computer system to perform the method, the method comprising:
receiving, by the computer system, item specification information that identifies a plurality of items to be added to a gift registry of a recipient user;
receiving, by the computer system, one or more delivery parameters specified by the recipient user, wherein the one or more delivery parameters comprise at least a date used to deliver at least some of the plurality of items;
providing, by the computer system, a selectable listing of the plurality of items;
receiving, by the computer system, a selection of at least a first item from among the plurality of items and payment information used to pay for the first item;
causing, by the computer system, a payment request for the first item to be processed based on the payment information;
receiving, by the computer system, a payment authorization related to the payment request; and
causing, by the computer system, delivery of the first item to the recipient user to be scheduled based on the one or more delivery parameters responsive to the payment authorization.

2. The method of claim 1, the method further comprising:
receiving an indication from the recipient user to deliver the first item after the delivery of the first item has been scheduled; and
causing the delivery of the first item to be re-scheduled regardless of the one or more delivery parameters based on the indication.

3. The method of claim 1, the method further comprising:
receiving an indication from the recipient user to exchange the first item for a second item; and
causing the second item to be provided to the recipient user instead of the first item based on the indication.

4. The method of claim 3, wherein the first item comprises a non-partner item and is associated with a first purchase price, and wherein the second item comprises a partner item and is associated with a second purchase price that is higher than the first purchase price, the method further comprising:
determining an adjusted purchase price based on the first purchase price and a multiplier, wherein causing the second item to be provided comprises determining that the adjusted purchase price is equal to or higher than the second purchase price.

5. The method of claim 3, wherein causing the second item to be provided to the recipient user instead of the first item comprises:
applying one or more fulfillment rules to determine whether the exchange from the first item to the second item is permissible; and
determining that the exchange is permissible based on the one or more fulfillment rules.

6. The method of claim 5, wherein determining that the exchange is permissible comprises determining whether a first type of the first item may be exchanged for a second type of the second item.

7. The method of claim 1, the method further comprising:
receiving an indication from the recipient user to exchange the first item for an amount of currency that is based on a purchase price of the first item; and
causing the amount of the currency to be transferred to a financial account of the recipient user instead of delivery of the first item.

8. The method of claim 1, the method further comprising:
receiving an indication that the first item is to be a group item, wherein the one or more giving users comprises a plurality of giving users that together purchase the first item.

9. The method of claim 1, the method further comprising:
generating one or more tracking reports that indicates at least a status of the plurality of items in the gift registry and includes one or more action items that, when interacted with, causes an item that was purchased to be fulfilled and/or exchanged.

10. The method of claim 1, wherein the first item comprises an item provided by a first retailer and wherein the plurality of items comprise a second item provided by a second retailer.

11. A system of fulfilling items from a gift registry based on one or more delivery parameters specified by a recipient user, the system comprising:
a computer system having one or more physical processors programmed with computer program instructions that, when executed by the one or more physical processors, cause the computer system to:
receive item specification information that identifies a plurality of items to be added to a gift registry of a recipient user;
receive one or more delivery parameters specified by the recipient user, wherein the one or more delivery parameters comprise at least a date used to deliver at least some of the plurality of items;
provide a selectable listing of the plurality of items;
receive a selection of at least a first item from among the plurality of items and payment information used to pay for the first item;
cause a payment request for the first item to be processed based on the payment information;
receive a payment authorization related to the payment request; and
cause delivery of the first item to the recipient user to be scheduled based on the one or more delivery parameters responsive to the payment authorization.

12. The system of claim 11, wherein the computer system is further programmed to:
receive an indication from the recipient user to deliver the first item after the delivery of the first item has been scheduled; and
cause the delivery of the first item to be re-scheduled regardless of the one or more delivery parameters based on the indication.

13. The system of claim 11, wherein the computer system is further programmed to:
receive an indication from the recipient user to exchange the first item for a second item; and
cause the second item to be provided to the recipient user instead of the first item based on the indication.

14. The system of claim 13, wherein the first item comprises a non-partner item and is associated with a first purchase price, and wherein the second item comprises a partner item and is associated with a second purchase price that is higher than the first purchase price, wherein the computer system is further programmed to:
determine an adjusted purchase price based on the first purchase price and a multiplier, wherein causing the second item to be provided comprises determining that the adjusted purchase price is equal to or higher than the second purchase price.

15. The system of claim 13, wherein the computer system is further programmed to:
apply one or more fulfillment rules to determine whether the exchange from the first item to the second item is permissible; and
determine that the exchange is permissible based on the one or more fulfillment rules, wherein the second item is caused to be provided to the recipient user instead of the first item based on the determination that the exchange is permissible.

16. The system of claim 15, wherein the computer system is further programmed to:
determine whether a first type of the first item may be exchanged for a second type of the second item, wherein the determination that the exchange is permissible is based on the determination that the first type of the first item may be exchanged for the second type of the second item.

17. The system of claim 11, wherein the computer system is further programmed to:
receive an indication from the recipient user to exchange the first item for an amount of currency that is based on a purchase price of the first item; and
cause the amount of the currency to be transferred to a financial account of the recipient user instead of delivery of the first item.

18. The system of claim 11, wherein the computer system is further programmed to:
receive an indication that the first item is to be a group item, wherein the one or more giving users comprises a plurality of giving users that together purchase the first item.

19. The system of claim 11, wherein the computer system is further programmed to:
generate one or more tracking reports that indicates at least a status of the plurality of items in the gift registry and includes one or more action items that, when interacted with, causes an item that was purchased to be fulfilled and/or exchanged.

20. The system of claim 11, wherein the first item comprises an item provided by a first retailer and wherein the plurality of items comprise a second item provided by a second retailer.
